(19) United States
(12) Patent Application Publication
(10) Pub. No.: US 2015/0168066 A1
(43) Pub. Date: Jun. 18, 2015

(54) Support System

(71) Applicant: Kazuki Takahashi, Toronto (CA)

(72) Inventor: Kazuki Takahashi, Toronto (CA)

(21) Appl. No.: 14/108,181

(22) Filed: Dec. 16, 2013

(51) Int. Cl. F26B 25/18

(52) U.S. Cl. CPC F26B 25/18

(57) ABSTRACT

A support system supports a garment with minimal contact between the system and the garment. The suspension allows for air-drying of the garment, and also enables debris to fall from the garment. The system comprises at least one rod for providing a supportive structure for the garment. A rod diameter is sized approximately half the diameter of a finger to enable debris from the garment to pass through a space formed between each rod and the garment. The diameter of the rod is less than half the diameter of a finger. The length of each rod can be different. The garment includes garment extension portions that engages correspondingly sized rods. A base tray forms a foundation for the rods. The base tray captures debris that falls from the space between the garment and the rod. Anti-bacterial solutions applied to the rods inhibits transfer of bacteria between garments.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a support system. More particularly, the invention relates to a stand for supporting a glove.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. One may expect that a glove is a garment covering the whole hand. Gloves have separate sheaths or openings for each finger and the thumb; if there is an opening but no covering sheath for each finger they are called fingerless gloves. Gloves protect and comfort hands against cold or heat, damage by friction, abrasion or chemicals, and disease; or in turn to provide a guard for what a bare hand should not touch.

Latex, nitrile rubber or vinyl disposable gloves are often worn by health care professionals as hygiene and contamination protection measures. In many instances gloves are made of materials including cloth, knitted or felted wool, leather, rubber, latex, neoprene, and metal.

Typically, wearing various different types of gloves such as, but not limited to, household cleaning gloves, snow gloves, work gloves, gardening gloves, etc. may result in sweaty hands and/or dampness of the gloves.

Typically, damp gloves often become unpleasant smelling. Some individuals may presume that the sweat within a damp glove is the cause of the smell. However, it is believed that bacteria living in the humid atmosphere of the damp glove are typically what cause this smell, as it is typically shown that a damp, warm environment like that found in a used glove may be a bacteria breeding ground.

In many instances, bacteria growth may get worse with continued use. One may also expect that exposure to these bacteria may result in skin conditions or even illness if ingested.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a side perspective view of an exemplary support system, an exemplary at least one rod, and an exemplary base tray, in accordance with an embodiment of the present invention;

FIGS. 2 and 3 illustrates diagrammatic views of an exemplary support system and an exemplary at least one rod having at least one central rod, at least one in-line short rod, and at least one short rod, where FIG. 2 illustrates a right view, and FIG. 3 illustrates a left view, in accordance with an embodiment of the present invention;

FIGS. 4 and 5 illustrate diagrammatic views of an exemplary support system, where FIG. 4 illustrates a front view, and FIG. 5 illustrates a rear view, in accordance with an embodiment of the present invention;

FIGS. 6 and 7 illustrates diagrammatic views of an exemplary base tray supporting an exemplary at least one rod, where FIG. 6 illustrates a top view, and FIG. 7 illustrates an underside view, in accordance with an embodiment of the present invention; and

FIG. 8 illustrates a side perspective view of an exemplary garment supported on an exemplary support system, in accordance with an embodiment of the present embodiment.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

In one embodiment of the present invention, a support system may be configured to support a garment with minimal contact between the support system and the garment. The suspension of the garment may enable air-drying of the garment, and also enable debris to fall from the garment. In some embodiments, the support system may comprise at least one rod for providing a supportive structure for the garment. The diameter of the at least one rod may be less than half the diameter of a finger. A rod diameter is sufficiently sized to enable debris from the garment to fall in a space that is formed between the at least one rod and the garment. Additionally, the length of each rod may be adjusted to compensate for variously sized and dimensioned garments. The garment may include at least one garment extension portion that at least partially engages the at least one rod, whereby each rod may support each garment extension. A base tray provides a foundation for the support system from which the at least one rod extends in a substantially vertical orientation.

In one embodiment, the at least one rod may include ten long, straight rods that extend in a substantially vertically orientation from the surface of the base tray. The base tray may be utilized to capture debris or moisture that falls from the garment. The garment may include, without limitation, a pair of gloves, mittens, a hat, a jacket, a pair of socks, a rain coat, and an umbrella. The garment extension may include, without limitation, a glove finger, a jacket arm, a hat peak, and a trouser leg.

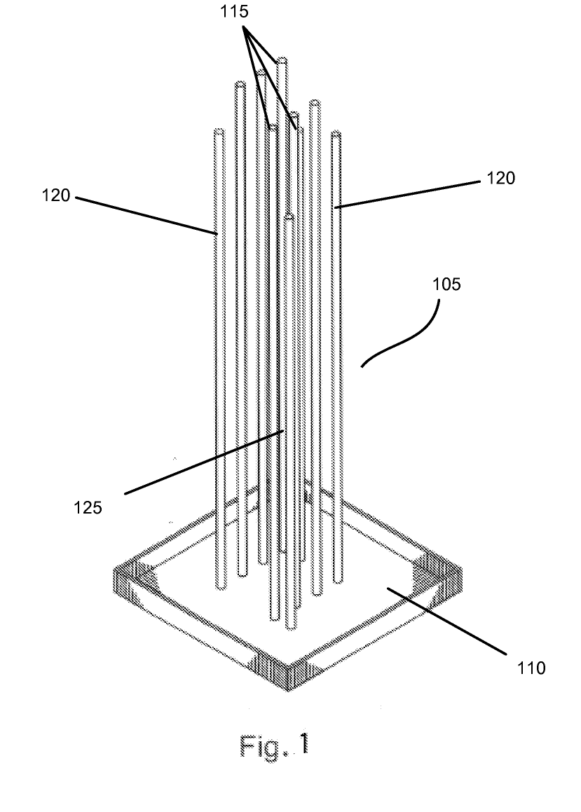

FIG. 1 illustrates a side perspective view of an exemplary support system, an exemplary at least one rod, and an exemplary base tray, in accordance with an embodiment of the present invention. In the present invention, a support system 100 may provide a support system for hanging a garment with minimal contact between the support system and the garment. The suspension of the garment may enable air-drying. In some embodiments, the support system may comprise at least one rod 105 for providing a supportive structure for the garment. The at least one rod may comprise variously sized rods that correspond to the garment size and dimension. The garment may include at least one garment extension portion that at least partially engages the at least one rod, whereby each rod may support each garment extension. A base tray provides a foundation for the support system from which the at least one rod extends in a substantially vertical orientation. The garment may include, without limitation, a pair of gloves, mittens, a hat, a jacket, a pair of socks, a rain coat, and an umbrella. The garment extension may include, without limitation, a glove finger, a jacket arm, a hat peak, and a trouser leg.

In one embodiment, the at least one rod may include ten long, straight rods that extend in a substantially vertically orientation from the surface of the base tray. Each rod may be sized differently to correspond with a garment extension portion. For example, without limitation, the at least one rod may include at least one central rod 115, at least one in-line short rod 120, and at least one short rod 125. However in other embodiments, any number of rods may be utilized. In some embodiments the diameter of the at least one rod may be less than half the diameter of a finger. A rod diameter is sufficiently sized to enable debris from the garment to fall in a space that is formed between the at least one rod and the garment. Additionally, the length of each rod may be adjusted to compensate for variously sized and dimensioned garments. A base tray 110 may form a foundation for the at least one rod, and serve to capture debris or moisture that falls from the garment.

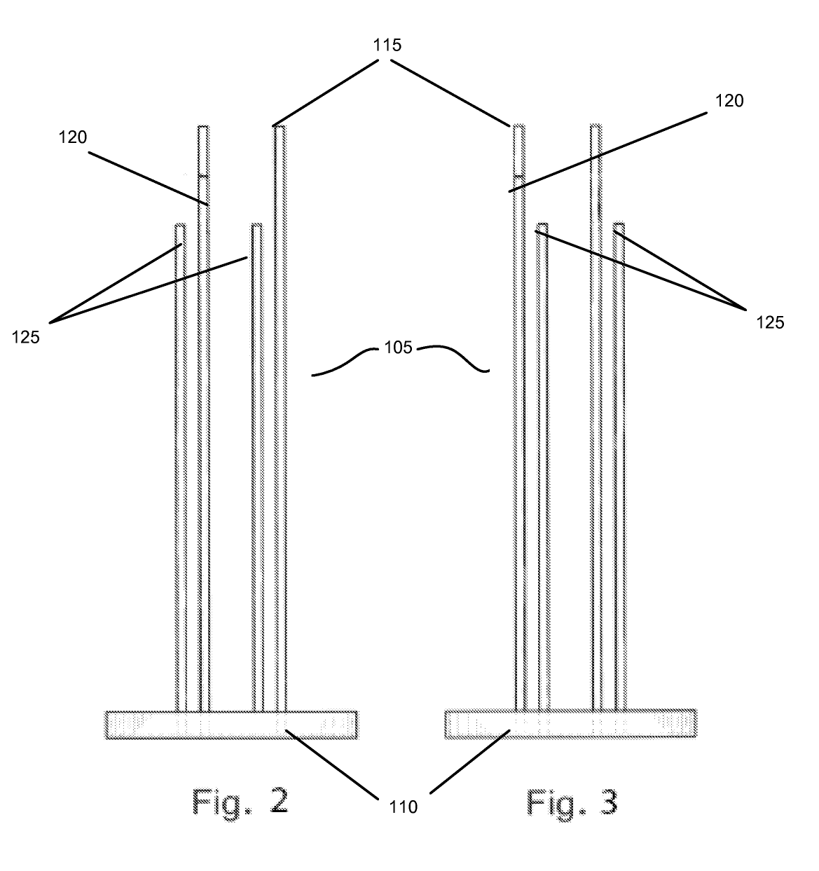

FIGS. 2 and 3 illustrates diagrammatic views of an exemplary support system and an exemplary at least one rod having at least one central rod, at least one in-line short rod, and at least one short rod, where FIG. 2 illustrates a right view, and FIG. 3 illustrates a left view, in accordance with an embodiment of the present invention. In the present invention, the support system may comprise at least one rod extending vertically from a base tray. The at least one rod may include a diameter approximately less than half the size of an average finger diameter. This particular diameter dimension may enable the at least one rod to fit into and support the at least one garment extension portion, while also creating sufficient space for the movement of air throughout a garment inner surface and any debris or water falling from a garment outer surface. Thus the glove stand may enable a user to air-dry a pair of damp or wet gloves naturally. For example, without limitation, a glove inner surface may engage the at least one rod by overlaying the at least one rod over the glove.

In the present embodiment, the support system may provide a natural air drying solution for gloves that have been used, washed or sprayed with anti-bacterial spray. The at least one rod may be treated with an anti-bacterial solution for helping to inhibit bacteria transfer between a plurality of garments on said at least one rod. Those skilled in the art will recognize that the use of the support system to dry gloves may help prevent bacteria from growing inside the gloves, which may be transferred to other surfaces if the glove users do not wash their hands properly after wearing damp gloves. The glove stand may be made of a multiplicity of suitable materials including, without limitation, wood, metal, ceramic, or virtually any kind of synthetic material.

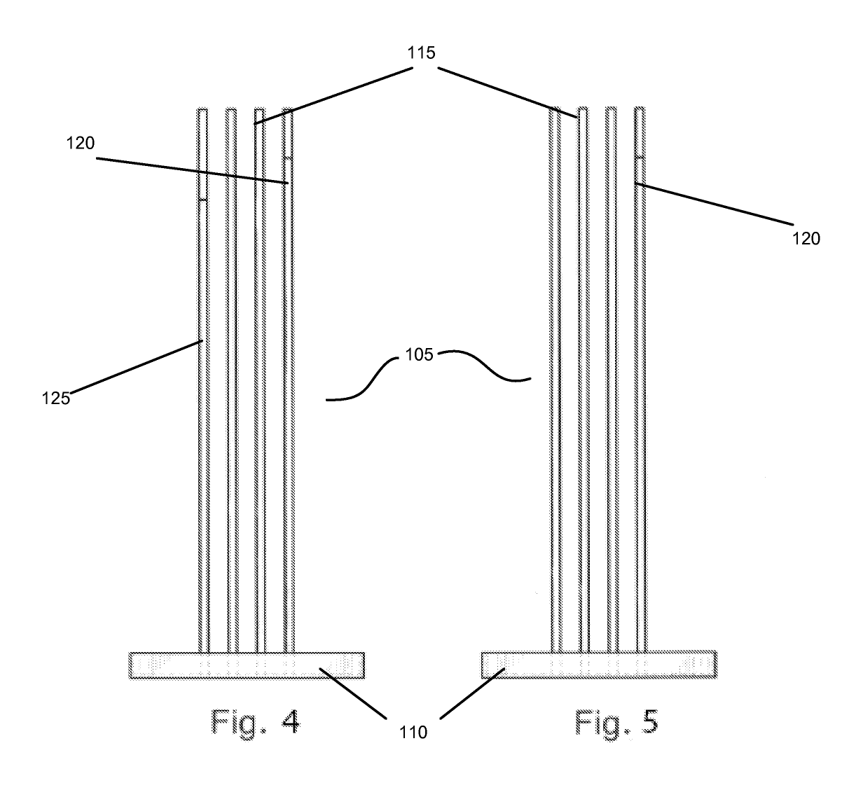

FIGS. 4 and 5 illustrate diagrammatic views of an exemplary support system, where FIG. 4 illustrates a front view, and FIG. 5 illustrates a rear view, in accordance with an embodiment of the present invention. In the present invention, the at least one rod may include spaces having similar dimensions to the spaces between the fingers of an average human hand. In addition, the at least one rod may include various lengths that conform to the various lengths of fingers on a hand. The at least one rod may include at least one central rod. The at least one central rod may be positioned where three middle fingers on a hand are located, replicating the index, ring, and pointer finger of each hand. The at least one central rod may include six rods. The at least one rod may further include at least one in-line short rod, which replicates the pinkies. The at least one rod may further comprise at least one short rod located slightly forward of the at least one central rod and the at least one in-line short rod. The at least one short rod may correspond to the thumbs of a hand.

It is contemplated that the at least one rod in some embodiments may be smaller or larger in diameter and that some embodiments may be implemented with rods of various different lengths or with fewer rods. For example, without limitation, in some embodiments the at least one central rod may have five different lengths for variously sized and shaped garments. In other embodiments all the rods may be equal in length. In yet another embodiments, the at least one short rod, which corresponds to thumbs may be removed.

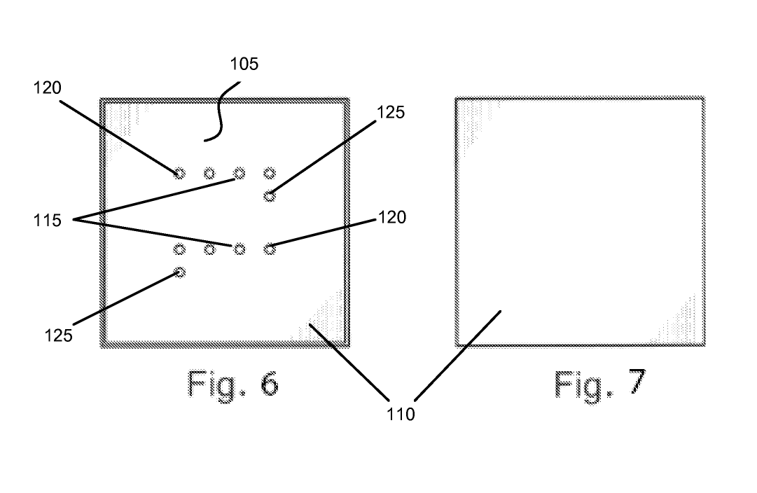

FIGS. 6 and 7 illustrates diagrammatic views of an exemplary base tray supporting an exemplary at least one rod, where FIG. 6 illustrates a top view, and FIG. 7 illustrates an underside view, in accordance with an embodiment of the present invention. In the present invention, the base tray may be configured to catch any water dripping water from the garment, such as a wet glove supported by the at least one rod. Those skilled in the art will readily recognize, in light of and in accordance with the teachings of the present invention that, in some alternate embodiments, the base tray may be implemented in a multiplicity of suitable shapes and designs. For example, without limitation, in some embodiments the base tray may comprise at least one aperture or channels to direct water away from the base tray.

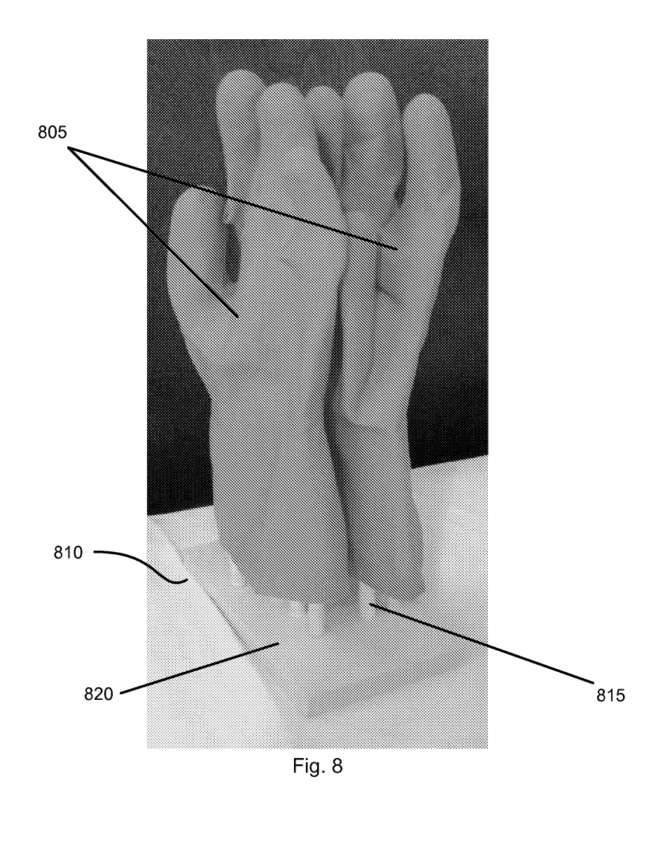

FIG. 8 illustrates a side perspective view of an exemplary garment supported on an exemplary support system, in accordance with an embodiment of the present embodiment. In the present invention, the garment may include a pair of gloves 805 supported on a glove stand 810. In operation, a user may place a pair of wet or damp gloves 805 on glove stand 810 by sliding each of the ten fingers of gloves 805 on a separate rod 815 extending vertically from a base tray 820. The user may then leave the gloves 805 on the glove stand 810 to allow the gloves 805 to air dry. The diameter of rods 815 are much smaller than the diameter of the fingers of gloves 805, which may enable air to easily circulate through and dry all parts of gloves 805. Alternatively, the glove stand 810 may be used as a display stand for gloves in a retail shop.

In one alternative embodiment, the support system with at least one rod may be manufactured as part of a product or machine to provide the similar outcome and purpose of drying gloves. For example, without limitation, a glove stand may be incorporated into a dishwasher to wash and dry a pair of glove or may be physically part of a kitchen sink or a wash sink to provide a kitchen glove stand. Some embodiments may be made as part of a dish tray or rack. Some embodiments may be designed with a base tray that not only collects water dripping from the wet glove but that also hold other kitchen or washing items such as, but not limited to, sponges, kitchen brushes, kitchen detergent, hand soap, hand soap bottles or dispensers. It is contemplated that in some instances the glove stands may be sold together with a pair of gloves such as, but not limited to, a pair of kitchen gloves, commercial gloves, garden gloves, work gloves, designer or fashion gloves, etc. Furthermore, some embodiments may be sold with a bottle of anti-bacteria spray.

Those skilled in the art will readily recognize, in light of and in accordance with the teachings of the present invention, that some embodiments may be implemented with various different features. For example, without limitation, the at least one rod may be heated/warmed by electricity to achieve better efficiency in drying a pair of damp gloves. This may be particularly desirable when drying winter woven gloves or winter sport gloves. In some embodiments, then the at least one rod can be lighted by ultraviolet light, which may aid in killing bacteria while gloves are air drying on the glove stand.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a glove stand according to the present invention will be apparent to those skilled in the art. Various aspects of the invention have been described above by way of illustration, and the specific embodiments disclosed are not intended to limit the invention to the particular forms disclosed. The particular implementation of the glove stand may vary depending upon the particular context or application. By way of example, and not limitation, the glove stands described in the foregoing were principally directed to average sized implementations; however, similar techniques may instead be applied to stands for holding smaller or larger types of gloves such as, but not limited to, children's gloves, golfing gloves, gloves with extended shafts for covering large portions of the arms, hockey gloves, baseball gloves, etc., which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A system comprising:
at least one rod, said at least one rod being configured to support a garment, said at least one rod comprising a rod diameter configured to at least partially receive said garment, said rod diameter being sized to form a space between said at least one rod and said garment, said space being operable to enable a debris to pass between said garment and said at least one rod; and
a base tray, said base tray being disposed to join with said at least one rod, said base tray being configured to receive said debris.

2. The system of claim 1, in which said support system comprises a glove stand.

3. The system of claim 2, in which said garment comprises a glove.

4. The system of claim 3, in which said rod diameter comprises a diameter configured to be operable to be approximately less than half a diameter of a finger.

5. The system of claim 4, in which said at least one rod comprises ten rods.

6. The system of claim 5, in which said ten rods comprise different lengths.

7. The system of claim 6, in which said ten rods comprise different diameters.

8. The system of claim 7, in which said at least one rod comprises at least one central rod configured to be operable to correspond to a middle finger diameter, and/or a ring finger diameter, and/or an index finger diameter.

9. The system of claim 8, in which said at least one rod comprises at least one in-line short rod configured to be operable to correspond to a pinky finger diameter.

10. The system of claim 9, in which said at least one rod comprises at least one short rod configured to be operable to correspond to a thumb diameter.

11. The system of claim 10, in which said at least one rod comprises a solution for enhancing drying of said garment.

12. The system of claim 11, in which said system comprises an anti-bacterial solution for helping to inhibit bacteria transfer between a plurality of garments on said at least one rod.

13. The system of claim 12, in which said garment comprising at least one garment extension.

14. The system of claim 13, in which said at least one garment extension comprises at least one sheathes on a glove, each sheath corresponding to a finger.

15. The system of claim 14, in which said base tray is configured to at least partially capture said debris.

16. The system of claim 15, in which said base tray comprises a generally rectangular shape.

17. The system of claim 16, in which said base tray comprises at least one aperture for carrying said debris.

18. The system of claim 17, in which said debris comprises a liquid.

19. A system comprising:
means for orienting a garment to overlay a support system;
means for positioning at least one garment extension over at least one rod;
means for forming a space between a rod diameter and a finger diameter;
means for passing a debris through said space; and
means for capturing said debris with a base tray.

20. A system consisting of:
at least one rod, said at least one rod comprising ten rods, said at least one rod further comprising at least one central rod configured to be operable to correspond to a middle finger diameter and/or a ring finger diameter and/or an index finger diameter, said at least one rod further comprising at least one in-line short rod configured to be operable to correspond to a pinky finger diameter, said at least one rod further comprising at least one short rod configured to be operable to correspond to a thumb diameter, said at least one rod being configured to support a garment, said garment comprising a glove, said garment further comprising at least one garment extension, said at least one rod further comprising a rod diameter configured to at least partially receive said garment, said rod diameter being sized to form a space between said at least one rod and said garment, said space being operable to enable a debris to pass between said garment and said at least one rod, said debris comprising a liquid; and
a base tray, said base tray being disposed to join with said at least one rod, said base tray being configured to receive said debris, said base tray comprising at least one aperture for carrying said liquid.
